(19) United States
(12) Patent Application Publication
(10) Pub. No.: US 2004/0018455 A1
(43) Pub. Date: Jan. 29, 2004

(54) Colour photographic print material

(76) Inventors: Markus Geiger, Leverkusen (DE); Axel Jochum, Koln (DE); Ralf Weimann, Leverkusen (DE)

Correspondence Address: CONNOLLY BOVE LODGE & HUTZ, LLP, P O BOX 2207, WILMINGTON, DE, 19899, US

(21) Appl. No.: 10/609,355

(22) Filed: Jun. 27, 2003

(30) Foreign Application Priority Data
Jul. 1, 2002 (DE) 102 29 471.2

(51) Int. Cl. G03C 7/34; G03C 1/46

(52) U.S. Cl. 430/505; 430/552; 430/553; 430/558

(57) ABSTRACT

A colour photographic print material having at least one red-sensitive silver halide emulsion layer containing at least one cyan coupler, at least one green-sensitive silver halide emulsion layer containing at least one magenta coupler and at least one blue-sensitive silver halide emulsion layer containing at least one yellow coupler, characterised in that the magenta coupler is of the formula

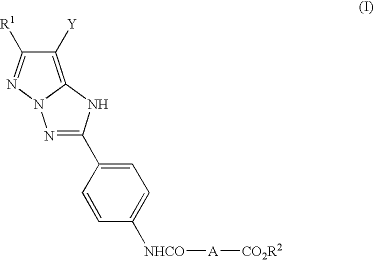

in which

R¹ means a tertiary alkyl residue,

Y means a hydrogen atom or a halogen atom,

A means an alkylene residue and

R² means an alkyl residue or an aryl residue and the cyan coupler is of the formula

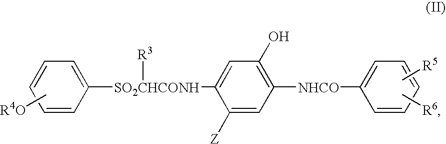

in which

R³ means a hydrogen atom or an alkyl group,

R⁴ means an alkyl group with at least 8 C atoms,

R⁵ means a halogen atom, a cyano, trifluoromethyl or alkoxycarbonyl group,

R⁶ means a hydrogen atom or R⁵ and

Z means a hydrogen atom or a group eliminable under the conditions of chromogenic development,

is distinguished by very good colour purity after long-term storage.

### COLOUR PHOTOGRAPHIC PRINT MATERIAL

This invention relates to a colour photographic print material having a combination of specific magenta couplers and specific cyan couplers.

Colour photographic print materials are in particular materials for reflection prints or displays, which most usually exhibit a positive image. They are thus not a recording material like colour photographic films.

Colour photographic print materials conventionally contain at least one red-sensitive silver halide emulsion layer containing at least one cyan coupler, at least one green-sensitive silver halide emulsion layer containing at least one magenta coupler and at least one blue-sensitive silver halide emulsion layer containing at least one yellow coupler.

EP 571 959 discloses novel magenta couplers which are distinguished by pure colours and excellent stability of the dyes produced therefrom. They are of the formula (I)

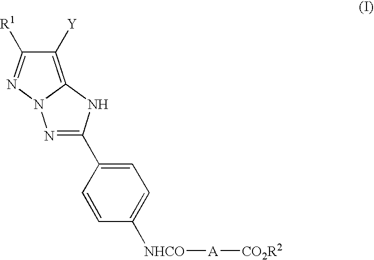

in which

R¹ means a tertiary alkyl residue,

Y means a hydrogen atom or a halogen atom,

A means an alkylene residue, in particular a —CH₂—CH₂ residue and

R² means an alkyl residue or an aryl residue,

and are used together with known cyan couplers, for example with the following compounds C-1 to C-4

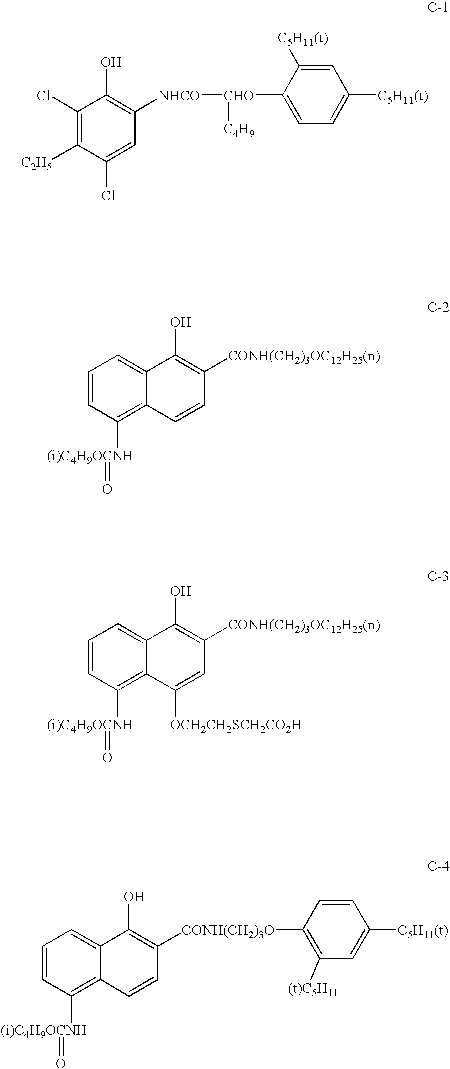

However, this combination has the disadvantage that, especially over long-term storage, the stability of the cyan and magenta dyes is very different and, as the paper ages, a colour cast develops which spoils the appearance of the image.

The object of the invention was to overcome the above-stated disadvantage. Surprisingly, this is achieved if the magenta couplers of the formula (I) are used together with the cyan couplers of the formula (II).

The present invention accordingly provides a print material having a support, at least one red-sensitive silver halide emulsion layer containing at least one cyan coupler, at least one green-sensitive silver halide emulsion layer containing at least one magenta coupler and at least one blue-sensitive silver halide emulsion layer containing at least one yellow coupler, characterised in that the magenta coupler is of the formula (I) and the cyan coupler is of the formula

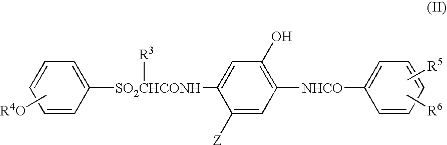

wherein in the formula (II)

R³ means a hydrogen atom or an alkyl group, in particular with 1 to 4 C atoms,

R⁴ means an alkyl group with at least 8 C atoms,

R⁵ means a halogen atom, a cyano, trifluoromethyl or alkoxycarbonyl group,

R⁶ means a hydrogen atom or R⁵ and

Z means a hydrogen atom or a group eliminable under the conditions of chromogenic development, in particular a chlorine atom.

Suitable cyan couplers are:

| | |
|---|---|
| II-1 | 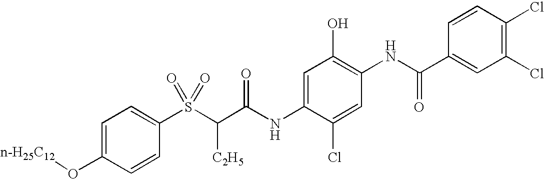 |
| II-2 | 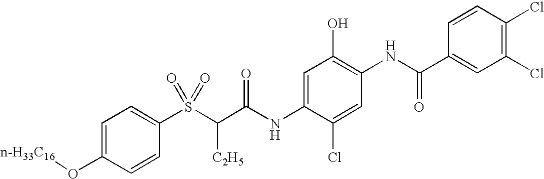 |
| II-3 | 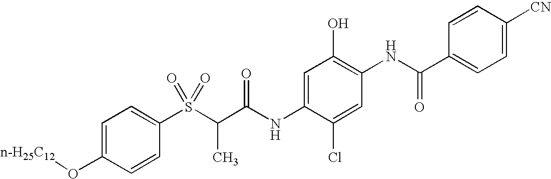 |
| II-4 | 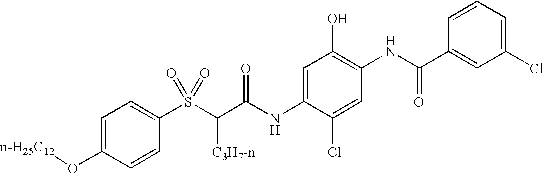 |
| II-5 | 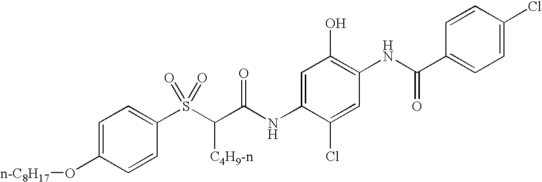 |
| II-6 | 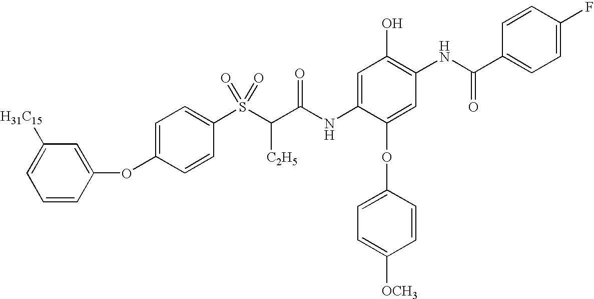 |
| II-7 | 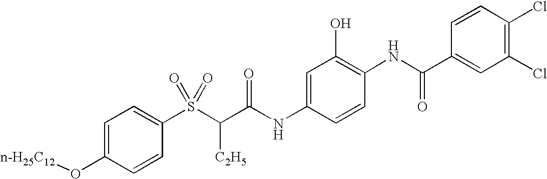 |
| II-8 | 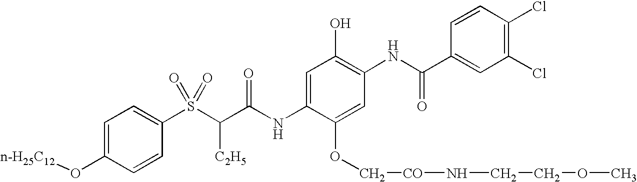 |
| II-9 | 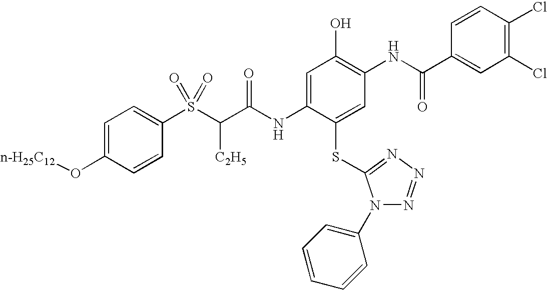 |
| II-10 | 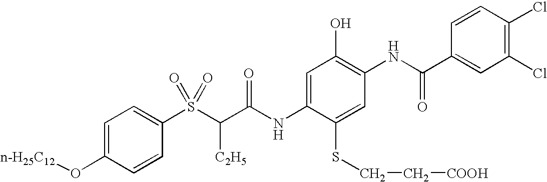 |
| II-11 | 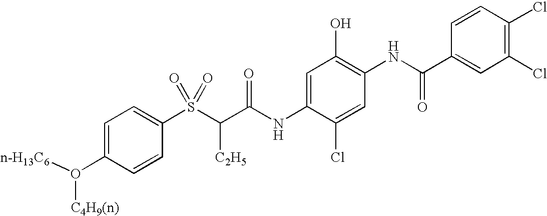 |
| II-12 | 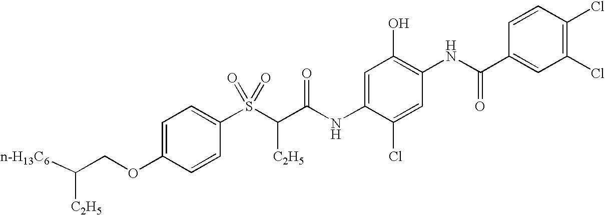 |

Examples of magenta couplers are:

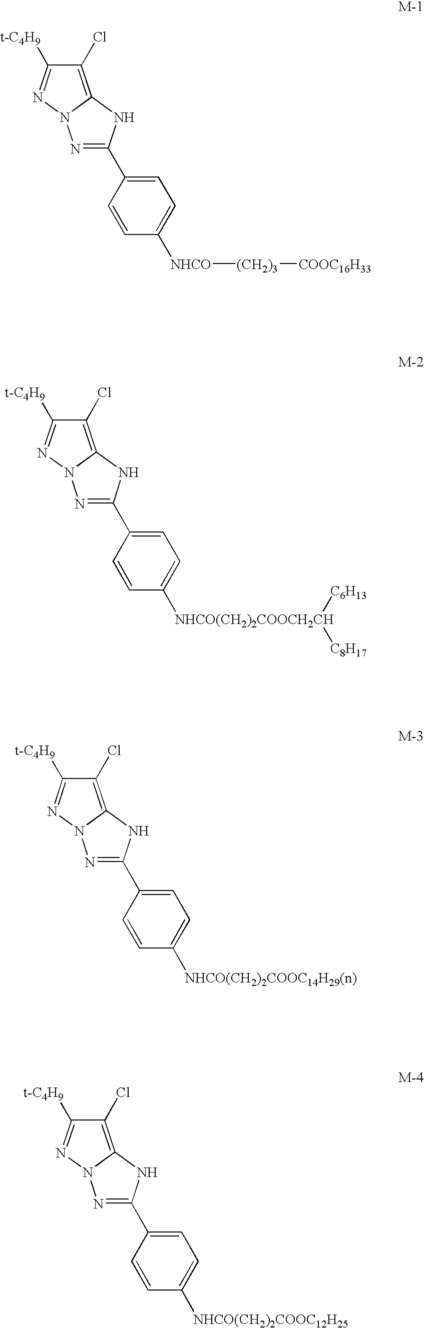

Examples of colour photographic print materials are colour photographic paper, colour reversal photographic paper and semi-transparent display material. A review may be found in Research Disclosure 37038 (1995), Research Disclosure 38957 (1996) and Research Disclosure 40145 (1997).

Photographic print materials consist of a support, onto which at least one photosensitive silver halide emulsion layer is applied. Suitable supports are in particular thin films and sheets. A review of support materials and auxiliary layers applied to the front and reverse sides thereof is given in Research Disclosure 37254, part 1 (1995), page 285 and in Research Disclosure 38957, part XV (1996), page 627.

The colour photographic print materials conventionally contain at least one red-sensitive, one green-sensitive and one blue-sensitive silver halide emulsion layer, optionally together with interlayers and protective layers.

Depending upon the type of photographic print material, these layers may be differently arranged. This is demonstrated for the most important products:

Colour photographic paper and colour photographic display material conventionally have on the support, in the stated sequence, one blue-sensitive, yellow-coupling silver halide emulsion layer, one green-sensitive, magenta-coupling silver halide emulsion layer and one red-sensitive, cyan-coupling silver halide emulsion layer; a yellow filter layer is not necessary.

The number and arrangement of the photosensitive layers may be varied in order to achieve specific results. Colour papers, for example, may also contain differently sensitised interlayers, by means of which gradation may be influenced.

The substantial constituents of the photographic emulsion layers are binder, silver halide grains and colour couplers.

Details of suitable binders may be found in Research Disclosure 37254, part 2 (1995), page 286 and in Research Disclosure 38957, part II.A (1996), page 598.

Details of suitable silver halide emulsions, the production, ripening, stabilisation and spectral sensitisation thereof, including suitable spectral sensitisers, may be found in Research Disclosure 37254, part 3 (1995), page 286, in Research Disclosure 37038, part XV (1995), page 89 and in Research Disclosure 38957, part V.A (1996), page 603.

Further red sensitisers which may be considered for the red-sensitive layer are pentamethinecyanines having naphthothiazole, naphthoxazole or benzothiazole as basic end groups, which may be substituted with halogen, methyl or methoxy groups and may be bridged by 9,11-alkylene, in particular 9,11-neopentylene. The N,N′ substituents may be C₄-C₈ alkyl groups. The methine chain may additionally also bear substituents. Pentamethines having only one methyl group on the cyclohexene ring may also be used. The red sensitiser may be supersensitised and stabilised by the addition of heterocyclic mercapto compounds.

The red-sensitive layer additionally be spectrally sensitised between 390 and 590 nm, preferably at 500 nm, in order to bring about improved differentiation of red tones.

The spectral sensitisers may be added to the photographic emulsion in dissolved form or as a dispersion. Both the solution and dispersion may contain additives such as wetting agents or buffers.

The spectral sensitiser or a combination of spectral sensitisers may be added before, during or after preparation of the emulsion.

Photographic print materials contain either silver chloride-bromide emulsions containing up to 80 mol % of AgBr or silver chloride-bromide emulsions containing above 95 mol % of AgCl.

Apart from the cyan and magenta couplers according to the invention, the materials contain yellow couplers and optionally further cyan and magenta couplers blended with the couplers according to the invention.

Details of colour couplers may be found in Research Disclosure 37254, part 4 (1995), page 288, in Research Disclosure 37038, part II (1995), page 80 and in Research Disclosure 38957, part X.B (1996), page 616. In print materials, the maximum absorption of the dyes formed from the couplers and the colour developer oxidation product is preferably within the following ranges: yellow coupler 440 to 450 nm, magenta coupler 540 to 560 nm, cyan coupler 625 to 670 nm.

The yellow couplers associated with a blue-sensitive layer in print materials are almost always two-equivalent couplers of the pivaloylacetanilide and cyclopropylcarbonylacetanilide series.

The non-photosensitive interlayers generally arranged between layers of different spectral sensitivity may contain agents which prevent an undesirable diffusion of developer oxidation products from one photosensitive layer into another photosensitive layer with a different spectral sensitisation.

Suitable compounds (white couplers, scavengers or DOP scavengers) may be found in Research Disclosure 37254, part 7 (1995), page 292, in Research Disclosure 37038, part III (1995), page 84 and in Research Disclosure 38957, part X.D (1996), pages 621 et seq.

The photographic material may also contain UV light absorbing compounds, optical brighteners, spacers, filter dyes, formalin scavengers, light stabilisers, antioxidants, Dₘᵢₙ dyes, plasticisers (latices), biocides and additives to improve coupler and dye stability, to reduce colour fogging and to reduce yellowing, and others. Suitable compounds may be found in Research Disclosure 37254, part 8 (1995), page 292, in Research Disclosure 37038, parts IV, V, VI, VII, X, XI and XIII (1995), pages 84 et seq. and in Research Disclosure 38957, parts VI, VIII, IX and X (1996), pages 607 and 610 et seq.

The layers of colour photographic materials are conventionally hardened, i.e. the binder used, preferably gelatine, is crosslinked by appropriate chemical methods.

Suitable hardener substances may be found in Research Disclosure 37254, part 9 (1995), page 294, in Research Disclosure 37038, part XII (1995), page 86 and in Research Disclosure 38957, part II.B (1996), page 599.

Once exposed with an image, colour photographic materials are processed using different processes depending upon their nature. Details relating to processing methods and the necessary chemicals are disclosed in Research Disclosure 37254, part 10 (1995), page 294, in Research Disclosure 37038, parts XVI to XXIII (1995), pages 95 et seq. and in Research Disclosure 38957, parts XVIII, XIX and XX (1996), pages 630 et seq. together with example materials.

### EXAMPLES

### Example 1

A colour photographic recording material suitable for rapid processing was produced by applying the following layers in the stated sequence onto a layer support of paper coated on both sides with polyethylene. Quantities are stated in each case per 1 m². The silver halide application rate is stated as the corresponding quantities of AgNO₃.

Layer structure 101

| | |
|---|---|
| Layer 1: | (Substrate layer) |
| | 0.10 g of gelatine |
| Layer 2: | (Blue-sensitive layer) |
| | Blue-sensitive silver halide emulsion (99.5 mol % chloride, |
| | 0.5 mol % bromide, average grain diameter 0.75 μm) prepared |
| | from 0.4 g of AgNO₃. |
| | 1.25 g of gelatine |
| | 0.4 g of yellow coupler GB-1 |
| | 0.1 g of yellow coupler GB-2 |
| | 0.30 g of tricresyl phosphate (TCP) |
| | 0.10 g of stabiliser ST-1 |
| Layer 3: | (Interlayer) |
| | 0.10 g of gelatine |
| | 0.06 g of DOP scavenger SC-1 |
| | 0.06 g of DOP scavenger SC-2 |
| | 0.12 g of TCP |
| Layer 4: | (Green-sensitive layer) |
| | Green-sensitive silver halide emulsion (99.5 mol % chloride, |
| | 0.5 mol % bromide, average grain diameter 0.45 μm) prepared |
| | from 0.14 g of AgNO₃. |
| | 1.10 g of gelatine |
| | 0.15 g magenta coupler M-3 |
| | 0.15 g of stabiliser ST-2 |
| | 0.20 g of stabiliser ST-3 |
| | 0.40 g of TCP |
| Layer 5: | (UV protective layer) |
| | 1.05 g of gelatine |
| | 0.35 g of UV absorber UV-1 |
| | 0.10 g of UV absorber UV-2 |
| | 0.05 g of UV absorber UV-3 |
| | 0.06 g of DOP scavenger SC-1 |
| | 0.06 g of DOP scavenger SC-2 |
| | 0.25 g of TCP |
| Layer 6: | (Rensensitive layer) |
| | Red-sensitive silver halide emulsion (99.5 mol % chloride, 0.5 |
| | mol % bromide, average grain diameter 0.48 μm) prepared |
| | from 0.28 g of AgNO₃. |
| | 1.00 g of gelatine |
| | 0.10 g of cyan coupler BG-1 |
| | 0.30 g of cyan coupler BG-2 |
| | 0.20 g of TCP |
| | 0.20 g of dibutyl phthalate |
| Layer 7: | (UV protective layer) |
| | 1.05 of gelatine |
| | 0.35 g of UV absorber UV-1 |
| | 0.10 g of UV absorber UV-2 |
| | 0.05 g of UV absorber UV-3 |
| | 0.15 g of TCP |
| Layer 8: | (Protective layer) |
| | 0.90 g of gelatine |
| | 0.05 g of optical brightener W-1 |
| | 0.07 g of polyvinylpyrrolidone |
| | 1.20 ml of silicone oil |
| | 2.50 mg of polymethyl methacrylate spacers, average particle |
| | size 0.8 μm |
| | 0.30 g of instant hardener H-1 |

Processing:

Samples of the material are exposed under a grey wedge through a red filter and processed as follows.

| | | |
|---|---|---|
| a) Colour developer-45 s-35° C. | | |
| Triethanolamine | 9.0 | g |
| N,N-Diethylhydroxylamine | 4.0 | g |
| Diethylene glycol | 0.05 | g |
| 3-Methyl-4-amino-N-ethyl-N-methane- | 5.0 | g |
| sulfonamidoethylaniline sulfate | | |
| Potassium sulfite | 0.2 | g |
| Triethylene glycol | 0.05 | g |
| Potassium carbonate | 22 | g |
| Potassium hydroxide | 0.4 | g |
| Ethylenediaminetetraacetic acid, disodium salt | 2.2 | g |
| Potassium chloride | 2.5 | g |
| 1,2-Dihydroxybenzene-3,4,6-trisulfonic acid | 0.3 | g |
| trisodium salt | | |
| make up with water to 1000 ml; pH 10.0 | | |
| b) Bleach/fixing bath-45 s-35° C. | | |
| Ammonium thiosulfate | 75 | g |
| Sodium hydrogen sulfite | 13.5 | g |
| Ammonium acetate | 2.0 | g |
| Ethylenediaminetetraacetic acid | 57 | g |
| (iron/ammonium salt) | | |
| Ammonia, 25% | 9.5 | g |
| make up with acetic acid to 1000 ml; pH 5.5 | | |

c) Rinsing-2 min-33° C.

d) Drying

The percentage yellow and magenta secondary densities of the cyan layer were then determined at cyan density D_{cyan}=1.0 (SD_{yellow(cyan)}, SD_{magenta(cyan)}), as was the percentage cyan secondary density of the magenta layer at magenta density D_{magenta}=1.0 (SD_{cyan(magenta)}). The results are shown in Table 1. The samples are also stored in darkness for 42 days at 80° C. and 50% relative humidity and the percentage reductions in density at maximum density for the magenta layer (ΔD_{magenta}) and the cyan layer (ΔD_{cyan}) were determined. Further samples are exposed to 15·10⁶lux·h of light from a daylight-standardised xenon lamp (100 klux to ANSI Standard IT.9.9). The reduction in density at D=0.6 for the magenta layer (ΔDL_{magenta}) and the cyan layer (ΔDL_{cyan}) is then determined. Optical density values were measured with an X-Rite 414 densitometer (status A filter).

The following compounds are used in Example 1:

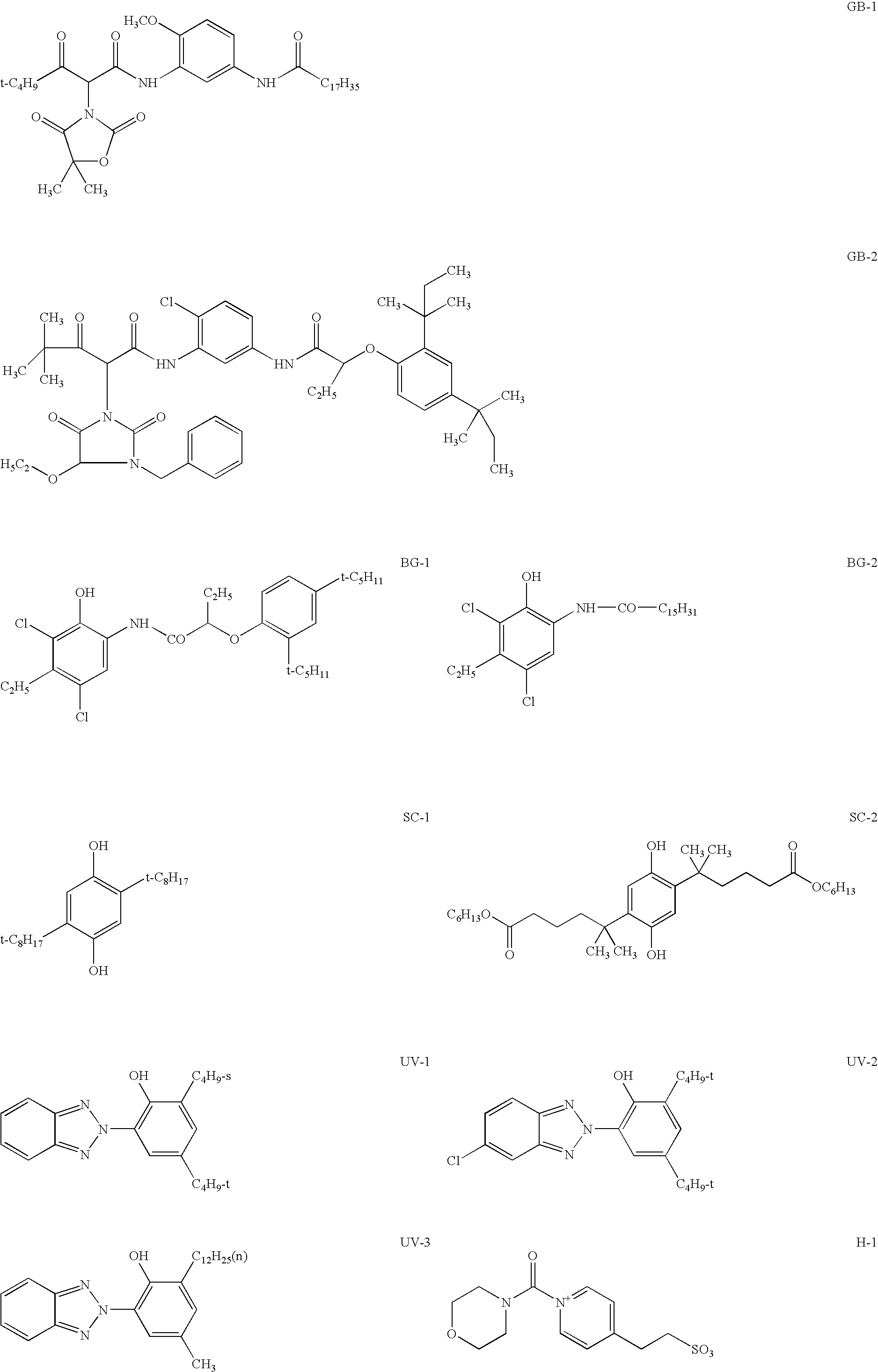

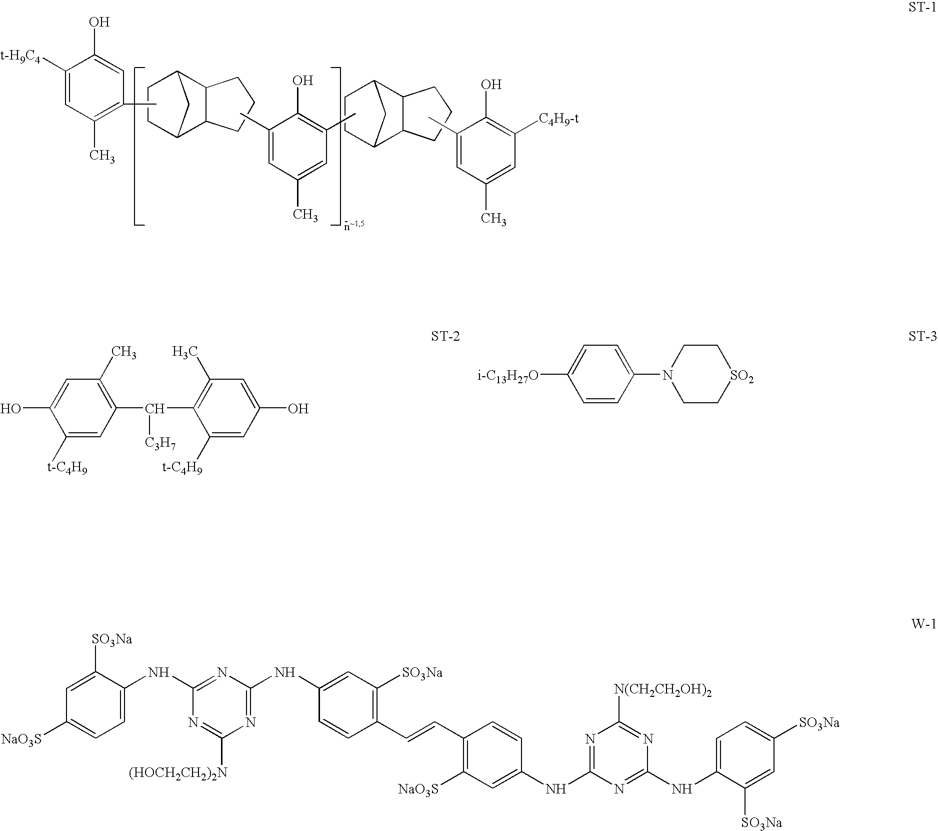

The other layer structures were produced in the same manner as structure 101, except that 0.4 g of the cyan coupler stated in Table 1 was used instead of 0.1 g of BG-1 and 0.3 g of BG-3 and the magenta coupler stated in Table 1 was used instead of M-3. The results are likewise shown in Table 1.

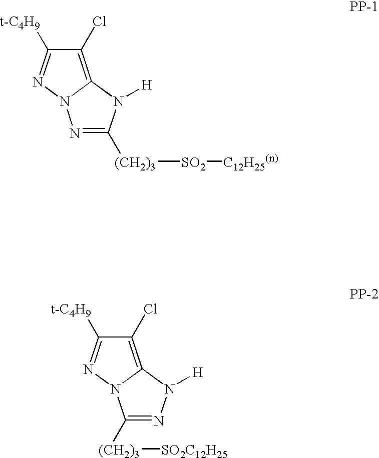

TABLE 1

| Layer | Cyan | Magenta | | | | | | | | |
|---|---|---|---|---|---|---|---|---|---|---|
| structure | coupler | coupler | SD_{cyan(magenta)} | SD_{magenta(cyan)} | SD_{yellow(cyan)} | ΔD_{cyan} | ΔD_{magenta} | ΔDL_{cyan} | ΔDL_{magenta} | |
| 101 | BG-1, BG-2 | M-3 | 23.7 | 39.4 | 29.2 | −21 | −17 | −19 | −24 | Comparison |
| 102 | C-2 | PP-1 | 23.6 | 39.5 | 28.5 | −21 | −15 | −18 | −25 | Comparison |
| 103 | C-2 | M-3 | 17.5 | 38.9 | 28.7 | −23 | −3 | −18 | −7 | Comparison |
| 104 | C-2 | PP-2 | 17.7 | 39.7 | 28.5 | −20 | −2 | −19 | −10 | Comparison |
| 105 | II-11 | PP-1 | 23.9 | 28.1 | 20.8 | −3 | −13 | −10 | −23 | Comparison |
| 106 | II-11 | M-3 | 17.4 | 28.3 | 20.9 | −4 | −1 | −9 | −7 | Invention |
| 107 | II-3 | M-3 | 17.6 | 27.9 | 20.5 | −2 | −2 | −10 | −8 | Invention |
| 108 | II-1 | PP-1 | 18.9 | 27.5 | 21.1 | −3 | −3 | −8 | −25 | Comparison |
| 109 | II-1 | M-3 | 17.5 | 27.6 | 20.8 | −2 | −1 | −8 | −6 | Invention |

As is clear from the Table, excellent dye stability combined with very high colour purity are only achieved when the cyan and magenta couplers according to the invention are used.

1. A colour photographic print material having at least one red-sensitive silver halide emulsion layer containing at least one cyan coupler, at least one green-sensitive silver halide emulsion layer containing at least one magenta coupler and at least one blue-sensitive silver halide emulsion layer containing at least one yellow coupler, characterised in that the magenta coupler is of the formula 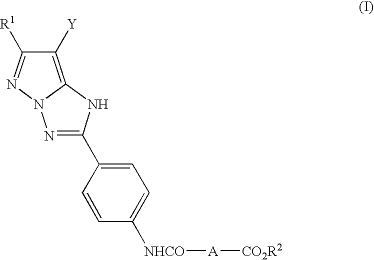
in which
R¹ means a tertiary alkyl residue,
Y means a hydrogen atom or a halogen atom,
A means an alkylene residue and
R² means an alkyl residue or an aryl residue and the cyan coupler is of the formula 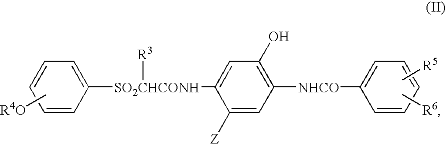
in which
R³ means a hydrogen atom or an alkyl group,
R⁴ means an alkyl group with at least 8 C atoms,
R⁵ means a halogen atom, a cyano, trifluoromethyl or alkoxycarbonyl group,
R⁶ means a hydrogen atom or R⁵ and
Z means a hydrogen atom or a group eliminable under the conditions of chromogenic development.

2. A colour photographic print material according to claim 1, characterised in that at least 95 mol % of the silver halides of the silver halide emulsion layers consist of AgCl.

3. A colour photographic print material according to claim 1, characterised in that the yellow coupler belongs to the group of pivaloylacetanilide two-equivalent couplers.

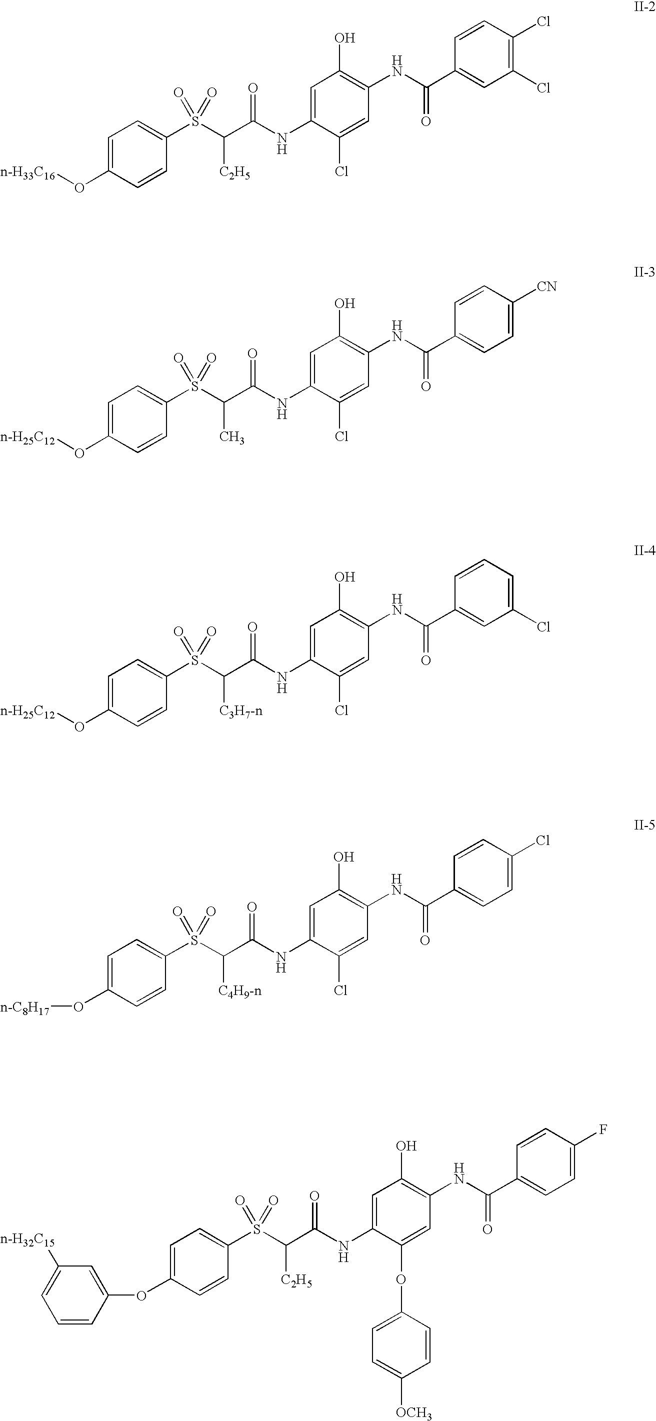

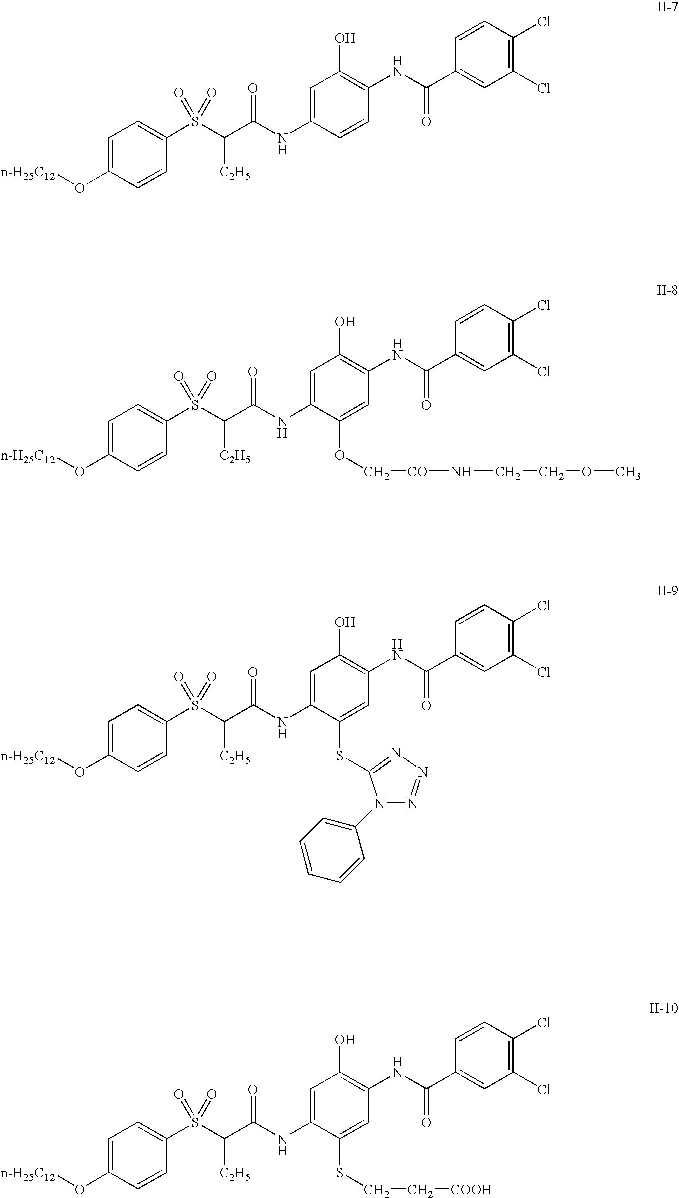

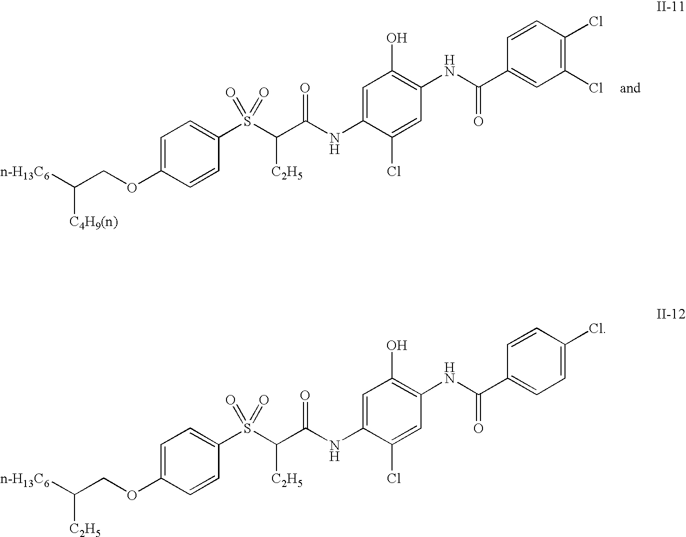

5. The material as claimed in claim 1, wherein the magenta coupler is selected from the group consisting of

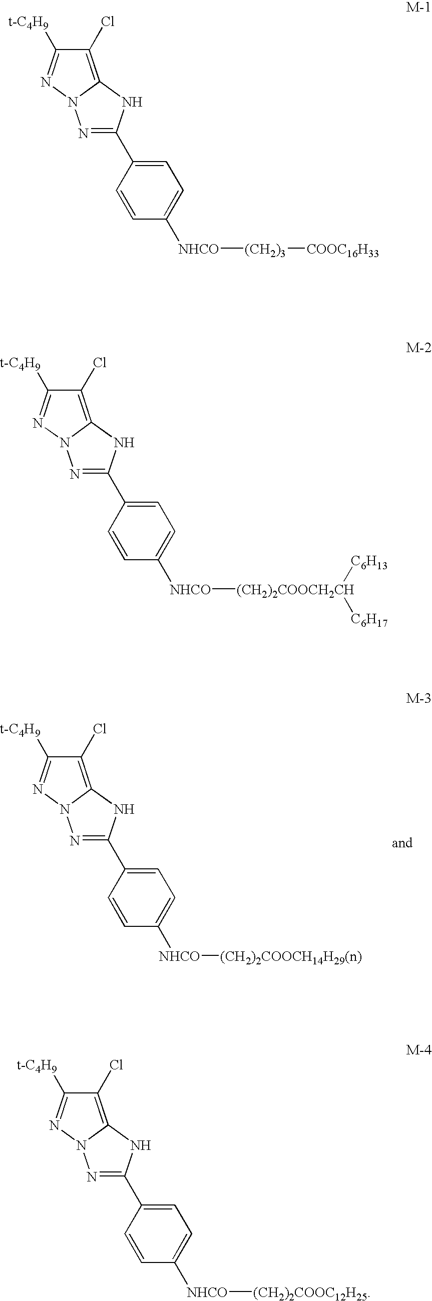

6. The material as claimed in claim 4, wherein the magenta coupler is selected from the group consisting of

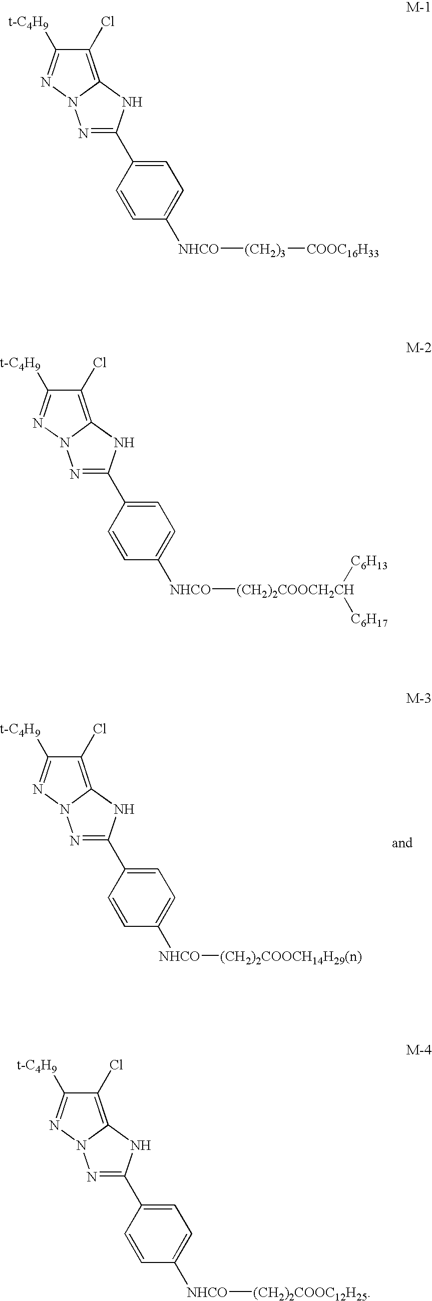

7. The material as claimed in claim 1, wherein the red-sensitive layer is spectrally sensitized between 390 and 590 nm.

8. The material as claimed in claim 7, wherein the red-sensitive layer is spectrally
